(19) United States
(12) Patent Application Publication
(10) Pub. No.: US 2010/0080216 A1
(43) Pub. Date: Apr. 1, 2010

(54) Real-time communication blocking for Dot Not Call" registered information

(76) Inventor: Jonathan Alan Croy, Seattle, WA (US)

Correspondence Address: MANELLI DENISON & SELTER PLLC;7th Floor, 2000 M Street, N.W., Washington, DC, 20036-3307, US

(21) Appl. No.: 12/289,423

(22) Filed: Oct. 28, 2008

Related U.S. Application Data
(60) Provisional application No. 61/136,731, filed on Sep. 29, 2008.

(51) Int. Cl. H04L 12/66

(52) U.S. Cl. 370/352

(57) ABSTRACT

A real-time call blocking system based on Session Internet Protocol (SIP), e.g., Voice Over Internet Protocol (VoIP) over both wireline and/or wireless systems using relevant Internet Protocol (IP) based systems. This also includes communications originating on traditional legacy or other non-SIP protocols that are converted to SIP somewhere during the call processing (e.g., using a media gateway to terminate a non-SIP device). A Session Internet Protocol (SIP)-based real time communication blocker comprises a do not call database, and a communication blocking proxy to intercept a communication from a commercial source. An intended recipient's identity is compared to entries in the do not call database. The intercepted communication (e.g., phone call, email, short message, etc. is blocked from being routed to an intended recipient if the intended recipient is listed in the do not call database.

The present application claims priority from U.S. Provisional Application No. 61/136,731 entitled “Real-Time Communication Blocking for “Do Not Call” Registered Information”, filed Sep. 29, 2008, the entirety of which is expressly incorporated herein by reference.

### BACKGROUND OF THE INVENTION

1. Field of the Invention

This invention relates generally to implementation of the “Do Not Call” registry. More particularly, it relates to communication blocking (e.g., call blocking) of Session Internet Protocol (SIP)-based communications over Voice Over Internet (VoIP) protocols and architectures.

2. Background of the Related Art

The United States' Federal Trade Commission (FTC) issued the amended Telemarketing Sales Rule (TSR) on Jan. 29, 2003. Like the original TSR issued in 1995, the amended Rule gives effect to the Telemarketing and Consumer Fraud and Abuse Prevention Act. This legislation gives the FTC and state attorneys general law enforcement tools to combat telemarketing fraud, give consumers added privacy protections and defenses against unscrupulous telemarketers, and help consumers tell the difference between fraudulent and legitimate telemarketing. Importantly, one significant amendment to the TSR prohibits calling consumers who have put their phone numbers on the National Do Not Call Registry. Key provisions limit when telemarketers may call consumers, and require transmission of Caller ID information.

Thus, outbound commercial calls are restricted by the government subject to a recipient having their phone number registered with a “Do Not Call” (DNC) list, e.g., the National Do Not Call Registry. As a practical matter, to implement current laws, businesses must procure and manage the various sources of DNC data and eliminate registered telephone numbers (TNs) from their outbound telemarketing. Non-compliance with the DNC list (e.g., calling a telephone number registered on the DNC) may result in a fine.

Many firms buy the DNC data from the National Do Not Call Registry, and incorporate it into their marketing systems so that lead or other targets will not be called if they are on the National Do Not Call Registry. However, such conventional systems and techniques leave it difficult at best to manage “Do Not Disturb” (DNC) data.

There is a need for a system and method that more accurately adheres to the DNC registry.

### SUMMARY OF THE INVENTION

In accordance with the principles of the present invention, a Session Internet Protocol (SIP)-based real time communication blocker, comprises a do not call database. A communication blocking proxy intercepts a communication from a commercial source, and compares an intended recipient's identity to entries in the do not call database. The intercepted communication is blocked from being routed to an intended recipient if the intended recipient is listed in the do not call database.

In accordance with another aspect, a communication blocking proxy broker comprises a communication blocking proxy broker. A plurality of different type communication blocking proxies corresponding to a unique list of do not communicate list. The proxy broker arbitrates disposition of a received communication attempt into a given wireless communication network to only one of the plurality of different type communication blocking proxies.

In accordance with yet another aspect, a Session Internet Protocol (SIP)-based real time communication blocker comprises a do not contact database. Communication blocking means intercepts a communication from a commercial source. Means for comparing compares an intended recipient's identity corresponding to the communication to entries in the do not contact database. The intercepted communication is blocked from being routed to an intended recipient if the intended recipient is listed in the do not contact database.

A method for real-time blocking a Session Internet Protocol (SIP)-based communication in accordance with yet another aspect comprises intercepting a communication from a commercial source. An intended recipient's identity corresponding to the communication is compared to entries in a do not contact database. The intercepted communication is blocked from being routed to the intended recipient if the intended recipient is listed in the do not contact database.

### BRIEF DESCRIPTION OF THE DRAWINGS

Features and advantages of the present invention will become apparent to those skilled in the art from the following description with reference to the drawings, in which:

FIG. 1 shows an exemplary real time call blocker providing call blocking determination using relevant Internet Protocol (IP) based systems (e.g., a Session Internet Protocol (SIP) based call management service), in accordance with the principles of the present invention.

FIG. 2 is a block diagram showing an exemplary real time call blocker shown in FIG. 1.

FIG. 3 shows SIP-based signal flow in a call blocking determination for a call management service, in accordance with the principles of the present invention.

FIG. 4 shows exemplary access to a national Do Not Call (DNC) database by a DNC data manager and server, in accordance with the principles of the present invention.

### DETAILED DESCRIPTION OF ILLUSTRATIVE EMBODIMENTS

The inventors have appreciated that conventional techniques and systems result in a significant chance of mishandled DNC data, potentially resulting in non-compliance with relevant laws. The inventors herein have also appreciated that people are continually registering new telephone numbers in the DNC list, with cell phone telephone numbers being a fast growing and fast changing segment of the DNC list. And within the mobile phone market (and even within the wireline telephone market), Voice Over internet Protocol (VoIP) phones are the wave of the future.

Voice-Over-Internet Protocol (VoIP) is a technology that emulates a phone call, but instead of using a circuit based system such as the telephone network, utilizes packetized data transmission techniques most notably implemented in the Internet.

The use of VoIP technology is growing quickly. Given VoIP technology, there are at least three VoIP scenarios:
1. A VoIP UA that is physically connected to a static data cable at a “home” address. For instance, an Analog Telephone Adapter (ATA) that is connected to the “home” data cable and uses traditional telephone devices.
2. A VoIP UA that is physically connected to a data cable at a location different than its “home” address. For instance, a laptop computer device utilized away from home as a VoIP software telephone would be a VoIP ‘visitor’ device as described by this scenario.
3. A VoIP UA that is wireless, physically disconnected from any data cable. In this situation, the VoIP UA connects to the VoIP service provider via either a wide-are wireless technology (e.g., cellular, PCS, WiMAX) or via a local-area wireless technology (e.g., Wireless Fidelity (WiFi), UWB, etc.) using a laptop computer or handheld device.

VoIP phone calls are routed to a VoIP voice gateway, from which they are passed on to their destination. A VoIP voice gateway or soft switch is a programmable network switch that can process the signaling for all types of packet protocols. Also known as a ‘media gateway controller,’ ‘call agent,’ or ‘call server,’ such devices are used by carriers that support converged communications services by integrating SS7 telephone signaling with packet networks. Softswitches can support, e.g., IP, DSL, ATM and frame relay.

VoIP telephone technology is quickly replacing conventional switched telephone technology. A location of a given VoIP device may be provisioned to be at a given geographic location, or queried from a home location register (HLR) in a mobile system.

With given VoIP technologies, a VoIP user must know the specific phone number of an individual, business, or other entity that they wish to call. There is no conventional technique for allowing a conference call between two or more VoIP users. In the Internet venue, users can find each other using a “chat room”, but the burden nevertheless remains on the user to search for, identify, and use a specific phone number or Universal Resource Identifier (URI) information to reach specific entities. This creates inefficiency and lack of flexibility with respect to the desire to establish a conference call, preventing VoIP users from managing their own communication needs and preferences. Generally, voice communication using VoIP technologies is limited to only point-to-point direct links between familiar or previously identified parties.

There is no known real-time call blocking system based on Session Internet Protocol (SIP).

The present invention relates to Session Internet Protocol (SIP)-based communications, e.g., Voice Over Internet Protocol (VoIP) over both wireline and/or wireless systems. This also includes communications originating on traditional legacy or other non-SIP protocols that are converted to SIP somewhere during the call processing (e.g., using a media gateway to terminate a non-SIP device).

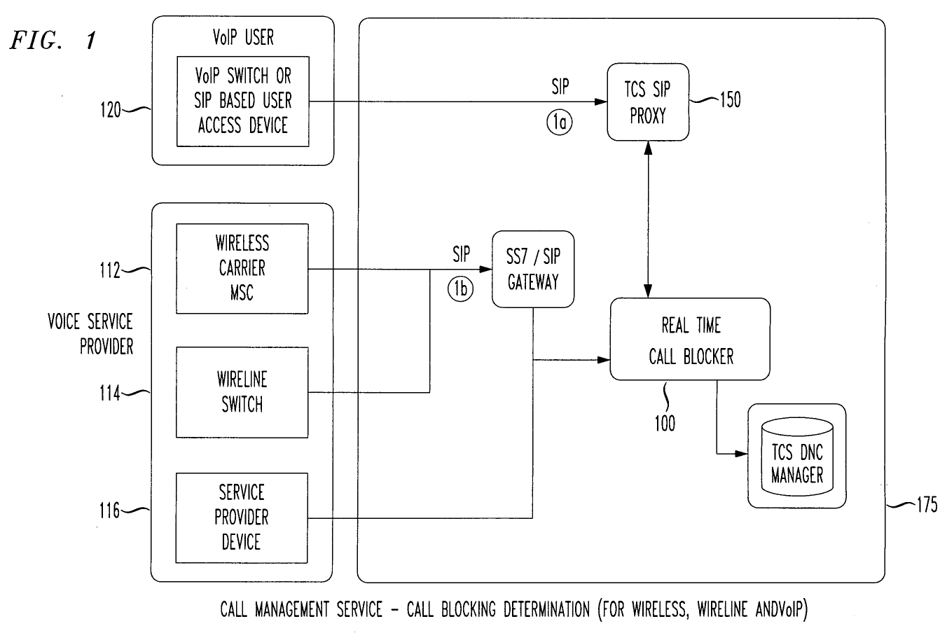

FIG. 1 shows an exemplary real time call blocker providing call blocking determination using relevant Internet Protocol (IP) based systems (e.g., a Session Internet Protocol (SIP) based call management service), in accordance with the principles of the present invention.

In particular, as shown in FIG. 1, a commercial source attempts to place a call via a relevant voice service provider 110. The commercial source may place their call via the voice service provider 110 utilizing any of, e.g., a wireless carrier message servicing center (MSC) 112, a wireline switch 114, or a service provider device 116. Signaling System No 7 (SS7) sources require use of an intervening SS7 to Session Internet Protocol (SIP) gateway 140 to access a real time call broker, whereas a native IP device (e.g., a VoIP device) 116 needs no protocol conversion to communicate with the real time call blocker 100.

The service provider IP device 116 may be any suitable calling system (e.g., SIP-based PBX or Predictive Dialers or soft-switches or other VoIP signaling interface devices), and may be implemented, e.g., with a VoIP positioning center (VPC) 175.

Importantly, the VoIP positioning center (VPC) is adapted to include a real time call blocker 100. The real time call blocker 100, e.g., a Do Not Call registry call blocker, looks at ‘dialed’ digits of the telephone number from a given commercial calling source and determines that the incoming call is not an emergency call (i.e., not a 9-1-1 call). If not an emergency call, a suitable application within the real time call blocker 100 then searches its copy of the Do Not Call (DNC) database and manager 125, and compares that to the dialed digits of the attempted incoming call. If the dialed telephone number is in fact on the “Do Not Call” (DNC) list maintained in the DNC database 125, the incoming Session Internet Protocol (SIP) signal attempting to establish the incoming call is modified in any suitable way to affect non-completion of the call to the intended party. Thus, if the attempted called party is registered in the DNC list, the relevant switch or server does not complete the associated incoming call.

One suitable way for the relevant switch or server to affect non-completion of the incoming call is by modification to the SIP signal attempting to establish the incoming call with a new called party number that the switch recognizes as non-dialable. Alternatively, the calling party may be connected with a recording indicating non-completion of the call.

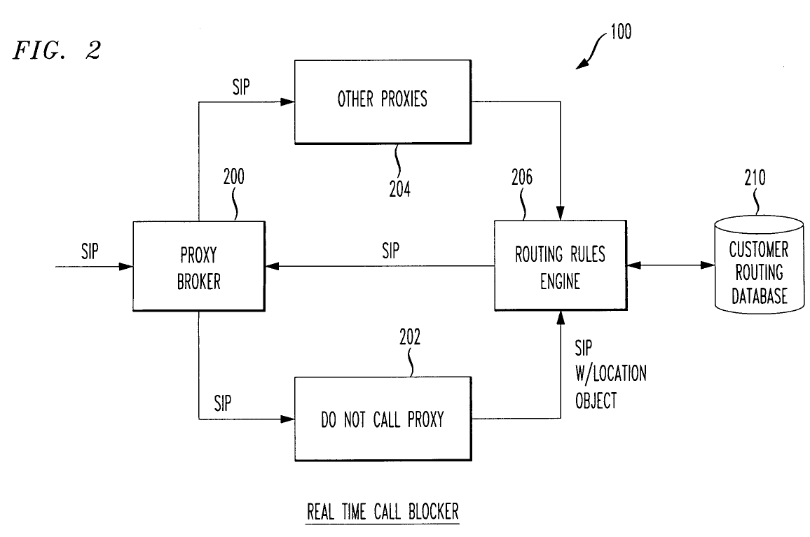

FIG. 2 is a block diagram showing an exemplary real time call blocker shown in FIG. 1.

In particular, as shown in FIG. 2, the real time call blocker 100 includes a proxy broker that initially receives the SIP signal attempting to establish an incoming call. The proxy broker arbitrates between a Do Not Call proxy 202 and any other proxies that may be implemented (e.g., a Do Not Email proxy, a Do Not Short Message proxy, etc.)

The Do Not Call proxy 202 and other proxies 204 communicate with a suitable routing rules engine 206, which in turn is in communication with a suitable customer routing database 210.

The use of a DNC proxy 202, and techniques as disclosed, provide a real-time backup to any other processes/techniques put in place upstream to ensure elimination of unwanted calls, e.g., Do Not Call calls.

A SIP-based real time call blocker with DNC proxy as disclosed may be optionally integrated with upstream systems to allow calls to DNC registered telephone numbers where even though the called telephone number is on the DNC list, the relevant commercial source has authority to contact the called party, e.g., where the commercial source has a pre-existing business relationship, etc.

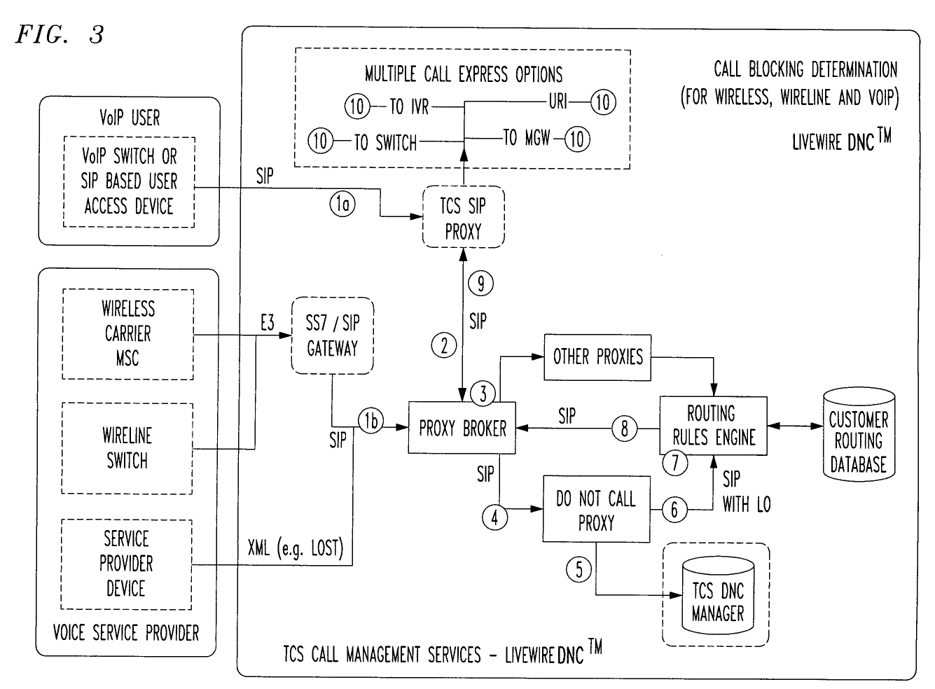

FIG. 3 shows SIP-based signal flow in a call blocking determination for a call management service, in accordance with the principles of the present invention.

In particular, as shown in step 1 of FIG. 3, a call originates and is sent to a real-time DNC call blocker 100 from any of a variety of devices/protocols 112, 114, 116.

In step 2, a SIP proxy 150 authenticates the requestor (FROM in SIP) and passes a SIP INVITE message to the SIP proxy broker 200.

In step 3, the SIP proxy broker 200 analyzes the incoming SIP signal relating to the attempted incoming call and determines that it requires a request to check the “Do Not Call” (DNC) list.

In step 4, the SIP proxy broker 200 routes the SIP signaling to the DNC proxy broker (application server) 200.

In step 5, the DNC proxy broker 200 checks the DNC database manager 125. The DNC database manager 125 modifies the SIP signaling to indicate if the destination telephone number is found and should be blocked.

In step 6, once the DNC check is complete, the DNC proxy 202 sends the SIP signaling to a suitable routing rules engine 206.

In step 7, the routing rules engine 206 determines the proper handling of the call, e.g., based on the customer routing rules database 210, and modifies the signaling appropriately.

In step 8, the signaling is routed back to the DNC proxy broker 200.

In step 9, the signaling is routed back to the SIP proxy 150, and the SIP proxy 150 egresses the call according to the signaling.

In step 10, the call is forwarded to, e.g., a PSTN via an appropriate media gateway to convert from SIP signaling to SS7 signaling; directed to a destination uniform resource identifier (URI); back to the originating switch/device indicating that the call is blocked, etc.

In an alternative embodiment, the blocked incoming call is routed to an interactive voice recognition (IVR)-like system to play a message to the caller to indicate that a “Do Not Call” (DNC) related call block has occurred.

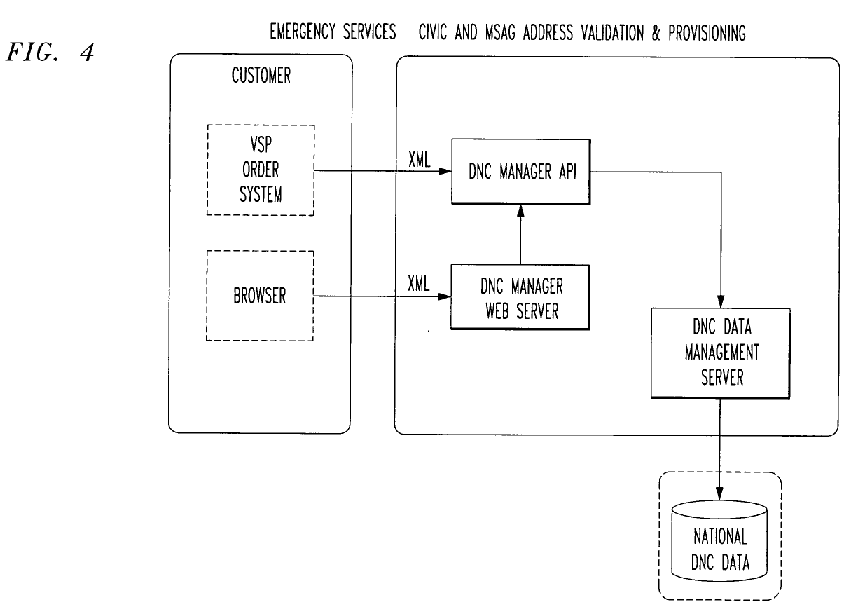

FIG. 4 shows exemplary access to a national Do Not Call (DNC) database by a DNC data manager and server, in accordance with the principles of the present invention.

In particular, as shown in FIG. 4, the real time call blocker 100 searches its (or other suitable) copy of the Do Not Call (DNC) database. This DNC database 125 may be maintained by a suitable service bureau and possibly maintained by a customer through an appropriate API.

SIP-based DNC call blocking in accordance with the principles of the present invention has particular application not only with companies that use outbound marketing, but with any unsolicited outbound call center, e.g., outbound telemarketing centers.

Call blocking may be implemented on a time of day basis (relative to the receiving party) for relevant phone numbers. For instance, certain numbers (or even all unsolicited phone calls dialed from a commercial source) may be prohibited from being called during night hours.

Whereas the embodiments of the present invention are described and shown with respect to SIP-based call blocking for registered telephone numbers, the invention is also applicable for blocking other packet communications such as short messages or email.

While the invention has been described with reference to the exemplary embodiments thereof, those skilled in the art will be able to make various modifications to the described embodiments of the invention without departing from the true spirit and scope of the invention.

What is claimed is:

1. A Session Internet Protocol (SIP)-based real time communication blocker, comprising:
a do not call database;
a communication blocking proxy to intercept a communication from a commercial source, and to compare an intended recipient's identity to entries in said do not call database;
wherein said intercepted communication is blocked from being routed to an intended recipient if said intended recipient is listed in said do not call database.

2. The Session Internet Protocol (SIP)-based real time communication blocker according to claim 1, wherein:
said intended recipient's identity is a telephone number.

3. The Session Internet Protocol (SIP)-based real time communication blocker according to claim 1, wherein:
said intended recipient's identity is an email address.

4. The Session Internet Protocol (SIP)-based real time communication blocker according to claim 1, wherein:
said do not call database is locally maintained.

5. The Session Internet Protocol (SIP)-based real time communication blocker according to claim 1, further comprising:
a proxy broker to arbitrate incoming communications between a do not call proxy and at least one other type proxy.

6. The Session Internet Protocol (SIP)-based real time communication blocker according to claim 1, further comprising:
said intercepted communication is routed to a system recording.

7. A communication blocking proxy broker, comprising:
a communication blocking proxy broker;
a plurality of different type communication blocking proxies each corresponding to a unique list of do not communicate list;
wherein said proxy broker arbitrates disposition of a received communication attempt into a given wireless communication network to only one of said plurality of different type communication blocking proxies.

8. The communication blocking proxy broker according to claim 7, wherein:
one of said plurality of different type communication blocking proxies implements a do not call (DNC) registry.

9. The communication blocking proxy broker according to claim 8, wherein:
said do not call registry comprises a plurality of telephone numbers.

10. The communication blocking proxy broker according to claim 7, wherein:
one of said plurality of different type communication blocking proxies implements a do not email (DNE) registry.

11. The communication blocking proxy broker according to claim 10, wherein:
said do not call registry comprises a plurality of email addresses.

12. The communication blocking proxy broker according to claim 7, wherein:
one of said plurality of different type communication blocking proxies implements a do not short message (DNSM) registry.

13. The communication blocking proxy broker according to claim 12, wherein:
said do not call registry comprises a plurality of short message addresses.

14. The communication blocking proxy broker according to claim 7, further comprising:
do not call registered information adapted to include registered telephone numbers to cause telephone calls to do not call registered telephone numbers to be blocked.

15. The communication blocking proxy broker according to claim 7, further comprising:
do not call registered information adapted to include registered short message addresses to cause short messages to do not short message registered addresses to be blocked.

16. The communication blocking proxy broker according to claim 7, further comprising:
do not call registered information adapted to include registered email addresses to cause email messages to do not email registered addresses to be blocked.

17. A Session Internet Protocol (SIP)-based real time communication blocker, comprising:
a do not contact database;
communication blocking means for intercepting a communication from a commercial source; and
means for comparing an intended recipient's identity corresponding to said communication to entries in said do not contact database;
wherein said intercepted communication is blocked from being routed to an intended recipient if said intended recipient is listed in said do not contact database.

18. The Session Internet Protocol (SIP)-based real time communication blocker according to claim 17, wherein:
said intended recipient's identity is a telephone number.

19. The Session Internet Protocol (SIP)-based real time communication blocker according to claim 17, wherein:
said intended recipient's identity is an email address.

20. The Session Internet Protocol (SIP)-based real time communication blocker according to claim 17, wherein:
said do not contact database is locally maintained.

21. The Session Internet Protocol (SIP)-based real time communication blocker according to claim 17, further comprising:
proxy broker means for arbitrating incoming communications between a do not call proxy and at least one other type proxy.

22. A method for real-time blocking a Session Internet Protocol (SIP)-based communication, comprising:
intercepting a communication from a commercial source;
comparing an intended recipient's identity corresponding to said communication to entries in a do not contact database; and
blocking said intercepted communication from being routed to said intended recipient if said intended recipient is listed in said do not contact database.

23. The method for real-time blocking a Session Internet Protocol (SIP)-based communication according to claim 22, wherein:
said intended recipient's identity is a telephone number.

24. The method for real-time blocking a Session Internet Protocol (SIP)-based communication according to claim 22, wherein:
said intended recipient's identity is an email address.

25. The method for real-time blocking a Session Internet Protocol (SIP)-based communication according to claim 22, wherein:
said do not contact database is locally maintained.

26. The method for real-time blocking a Session Internet Protocol (SIP)-based communication according to claim 22, further comprising:
arbitrating incoming communications between a do not call proxy and at least one other type proxy.

27. The method for real-time blocking a Session Internet Protocol (SIP)-based communication according to claim 22, further comprising:
routing said intercepted communication to a system recording.
